(19) United States
(12) Patent Application Publication
(10) Pub. No.: US 2008/0112670 A1
(43) Pub. Date: May 15, 2008

(54) Wavelength filter

(76) Inventors: David Brooks, Hod Hasharon (IL); Moshe Price, Hod Hasharon (IL); Moti Margalit, Zichron Yaakove (IL)

Correspondence Address: EMPK & Shiloh, LLP, 116 JOHN ST,, SUITE 1201, NEW YORK, NY, 10038, US

(21) Appl. No.: 11/599,300

(22) Filed: Nov. 15, 2006

(51) Int. Cl. G02B 6/34; B29D 11/00

(52) U.S. Cl. 385/37; 216/24

(57) ABSTRACT

The present invention provides a method and apparatus for improved wavelength filtering and for producing a wavelength filter with improved wavelength filtering. The wavelength filter may include a waveguide to transmit an optical signal through a substrate, and a periodic series of grooves across a portion of the waveguide to effect reflection of a portion of the signal, the grooves having varying depths into the waveguide, wherein the varying depths affect a spectrum of the reflected portion.

### BACKGROUND OF THE INVENTION

In certain applications of optical waveguides wavelength filters are needed, for example, for the separation of channels in Wavelength Division Multiplexing (WDM) systems or for gain equalization of amplifiers. Bragg Gratings with high refractive index contrast are widely used as wavelength filters in these applications, as they consume only relatively short segment of the Waveguide and their efficiency as filters may be very high.

Bragg Gratings are based on the principle of Bragg reflection. When light propagates through periodically alternating regions of higher and lower refractive index, it is partially reflected at each interface between those regions. When the round trip of the light between two reflections is an integral number of wavelengths, all the partial reflections add up in phase, and the total reflection may be nearly 100%. For a grating period P and an average refractive index n, the reflected wavelength will be λ_{Bragg}=2nP. For other wavelengths, the out-of-phase reflections end up canceling each other, resulting in high transmission.

One drawback of Bragg Gratings as wavelength filters is that the resulting reflection spectrum suffers from large sidelobes.

Reference is now made to FIG. 1, which is an illustration of a wavelength filter grating 100 as known in the art. Grating 100 may include periodically alternating sections 30 with a first refractive index and sections 32 with a second refractive index, for example, with a constant period P. An input signal 12 may propagate through grating 100. A reflected signal 14 may include a narrow band of wavelengths around a wavelength λ which fulfill the condition λ=2nP as described above and therefore may be reflected back from grating 100. A transmitted signal 16, including wavelengths other than λ, may be transmitted forth.

Reference is now made to FIG. 2, which is a graph 200 illustrating a possible reflection spectrum of a reflected signal 14 which may be reflected by a grating 100 as described above with reference to FIG. 1. For illustration only, the wavelength axis (which is notated with WL) is calibrated so that the point “0” indicates the wavelength λ, the point “50” indicates the wavelength λ+50[nm], the point “−50” indicates the wavelength λ-50 [nm], etc. As illustrated by graph 200, the reflection spectrum of a reflection signal 14 may have large sidelobes.

In order to reduce these sidelobes, it is possible to apodize the grating by changing the grating period along the grating. However, the change in the grating period should be very delicate in order to reduce the sidelobes without damaging the quality of the filter. Currently, there is no technology which may enable such delicate changes in the grating period and the quality of the filters may decrease significantly as a result of the inaccuracy. The quality of the filter increases as the transmission of the filtered wavelength is closer to 0 and the transmission of other wavelengths is closer to 100%.

Therefore, a different kind of apodization is needed in order to reduce the sidelobes of the reflected waveguide spectrum without damaging the quality of the filter.

### SUMMARY OF THE INVENTION

Embodiments of the present invention may provide a method and apparatus for improved wavelength filtering. The wavelength filter may include a waveguide to transmit an optical signal through a substrate, and a periodic series of grooves across a portion of the waveguide. The series of grooves may effect reflection of a portion of the signal. The series of grooves may be of varying depths into the waveguide, wherein the varying depths may affect a spectrum of the reflected portion of the signal. The spectrum may be further affected by the period of the series of grooves and/or by the average refraction index of the periodic series of grooves. The spectrum may be substantially a spatial Fourier transform of an envelope shape of the varying depths of the series of grooves.

Embodiments of the present invention may provide a method for wavelength filtering. The method may comprise the step of producing across a portion of a waveguide a periodic series of grooves with varying depths into the waveguide, for example, by projecting a beam of ions on a substrate. The beam of ions may have varying density of ions along a cross-section line of the beam of ions, for example, cross section line substantially parallel to the waveguide. In order to increase the etching effectiveness of the ions it is also possible to induce gas which reacts chemically with the ions and the material of the substrate. The method may further comprise the step of inputting an optical signal through the series of grooves, wherein the varying depths affect a spectrum of a reflected portion of the signal.

Embodiments of the present invention may provide a method for producing a wavelength filter which may have grooves across a waveguide in a substrate, for example, grooves with varying depths into the waveguide. The method may comprise calculating an envelope shape of the varying depths corresponding to a desired reflection spectrum of the filter. The method may further comprise preparing an aperture plate adapted to produce the calculated envelope shape, for example, by producing apertures with varying sizes and densities in the aperture plate, according to the calculated envelope shape. The method may further comprise projecting a beam of ions through the aperture plate onto the substrate, wherein the beam may be structured by the aperture plate to etch grooves having the envelope shape. For example, by projecting the beam through the aperture plate, varying density of ions along a cross-section line of the beam of ions may be produced. The cross section line may be substantially parallel to the waveguide. The varying depths of the grooves may correspond to the varying density of ions.

A method according to embodiments of the present invention may further include inducing gas which reacts chemically with the ions and the material of the substrate, for example, to increase the etching effectiveness of the ions.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of a wavelength filter grating as is known in the art;

FIG. 2 is a graph illustrating a possible reflection spectrum of a reflected signal which may be reflected by a grating as illustrated in FIG. 1 as is known in the art;

FIG. 3 is an illustration of a wavelength filter grating according to embodiments of the present invention;

FIG. 4 is a graph illustrating a possible reflection spectrum of a reflected signal which may be reflected by a grating as illustrated in FIG. 3;

FIG. 5 is an illustration of a system enabling production of a grating as illustrated in FIG. 3;

FIG. 6 is a flowchart describing a method for wavelength filtering according to embodiments of the present invention;

FIG. 7 is a flowchart describing a method for producing a wavelength filter according to embodiments of the present invention; and

FIG. 8 is a flowchart describing an additional method for producing a wavelength filter according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

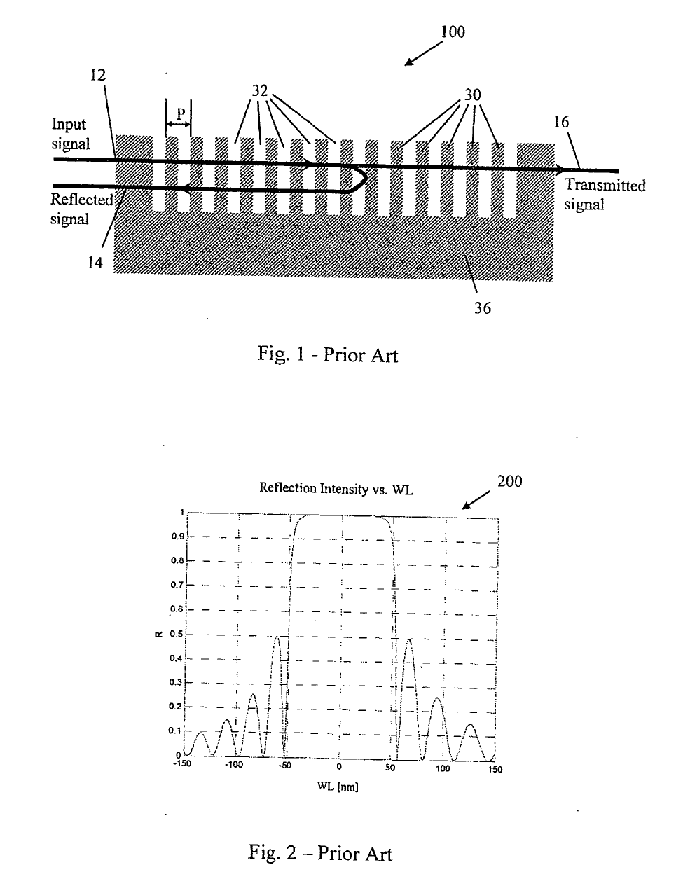

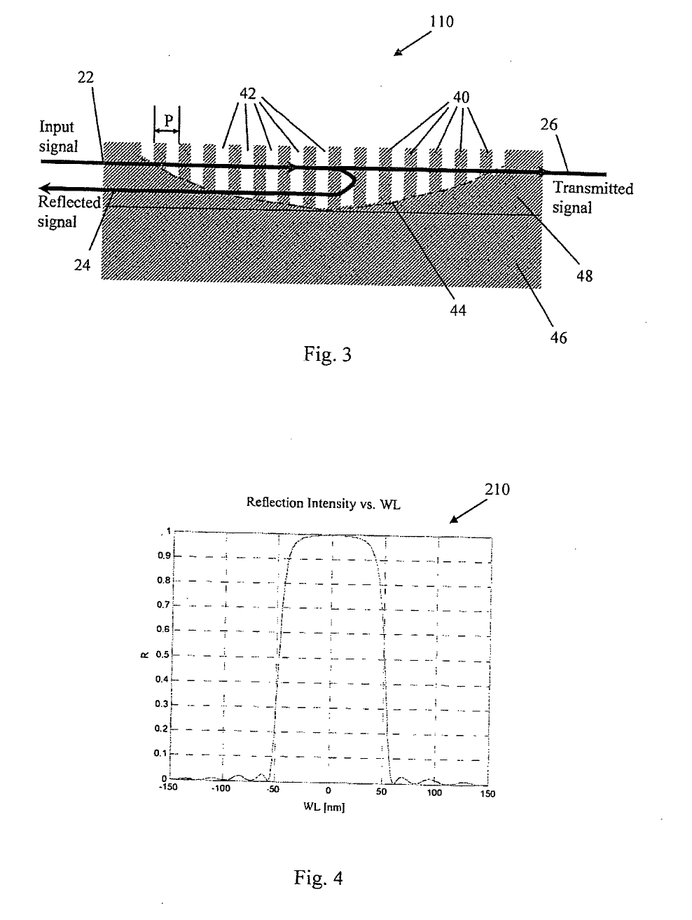

The present invention may provide waveguide filters based on gratings with three dimensional structures that may produce reflection spectrum with reduced sidelobes, without damaging the quality of the wavelength filtering. The present invention may provide varying three dimensional structures along the grating, for example, varying depths of grooves along the grating, that is—along a line parallel to the waveguide. The imaginary line connecting the bottoms of the grooves with the varying depths, as seen for example in FIGS. 1 and 3, may be called the envelope shape of the depths of the grooves. The varying depths of the grooves along the grating may provide varied reflection intensity along the grating. Therefore, different envelope shapes of the varying depths along the grating may provide different shapes of reflection spectrum, for example, without sidelobes. The reflection spectrum may be pre-designed by providing a certain envelope shape to the varying depths along the grating. In principle, the reflection spectrum may be substantially represented as a spatial Fourier transform of the envelope shape of the varying depths along the grating.

Reference is made to FIG. 3, which is an illustration of a wavelength filter grating 110 according to embodiments of the present invention. The length of Grating 110 may be typically shorter then 50 micron. Grating 110 may be, for example, a portion of a waveguide 48 in substrate 46. Grating 110 may include periodically alternating sections 40 with a first refractive index and sections 42 with a second refractive index, for example, with a period P. Sections 42 may be, for example, narrow grooves in a substrate 46, and sections 40 may be integral parts of substrate 46. Sections 42 may have varying depths along the grating, for example, with an envelope shape 44. An input signal 22 may propagate through grating 110. A reflected signal 24 may include a narrow band of wavelengths around a wavelength λ which fulfill the condition λ=2nP as described above and therefore may be reflected back from grating 110. Envelope shape 44 of the varying depths of sections 42 may provide varied reflection intensity along the grating, thus providing a specific shape to the reflection spectrum, for example, substantially without sidelobes. For example, a substantially Gaussian envelope shape 44 may provide a substantially Gaussian shape to the reflection spectrum, because a Fourier transform of a Gaussian function is also a Gaussian function. In other embodiments, a substantially sinc function envelope shape 44 may provide a substantially rectangular shape to the reflection spectrum, because a Fourier transform of a sine function is a rectangular function. A transmitted signal 26, including wavelengths other than λ, may be transmitted forth. The width of sections 40 and 42 may be, for example, in the order of few hundreds of nanometers, according to the desired reflected wavelength. Delicate changes in the period P along grating 110 may also affect the reflection spectrum together with the differential depth of sections 42.

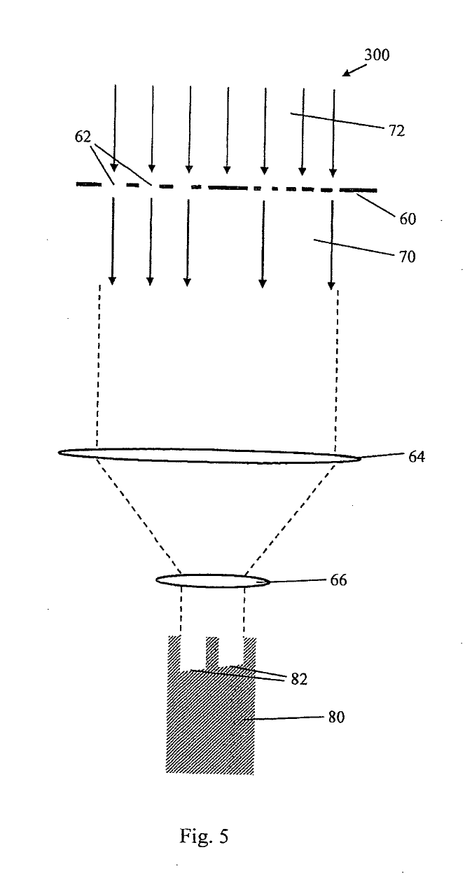

Reference is now made to FIG. 4, which is a graph 210 illustrating a possible reflection spectrum of a reflected signal 24 which may be reflected by a grating 110 as described above with reference to FIG. 3. For illustration only, the wavelength axis (which is notated with WL) is calibrated so that the point “0” indicates the wavelength λ, the point “50” indicates the wavelength λ+50[nm], the point “−50” indicates the wavelength λ-50 [nm], etc. As illustrated by graph 210, the reflection spectrum of a reflection signal 24 may have reduced sidelobes, as a result of the varying depths of sections 42, as described above. The reflection spectrum may be pre-designed by providing certain envelope shape to the varying depths of sections 42 along grating 110.

As described herein below, sections 42 may be produced, for example, by a beam of ions projected on substrate 46. Reference is now made to FIG. 5, which is an illustration of a system 300 enabling production of sections 42 with varying depths. Structured beam of ions 70 may be formed by an aperture plate 60 including for example, apertures 62, by projecting beam of ions 72 on plate 60. The varying sizes and density of apertures 62 along aperture plate 60 may control the density and/or intensity along the cross-section of beam 70 in a direction substantially parallel to the plane of the drawing. Beam 70 may than pass through concentration or focusing optics 64 and 66 to concentrate the beam and to direct it to desired locations on substrate 80. The focusing optics 64 and 66 may function also as an optical reduction or shrinking system. This system may reduce the dimensions of the beam structured by the aperture plate by a factor equal to the optical power of the optics, 200 for example, so that a period of, for example, 10 micron of the grating on plate 60 may be reduced to 50 nm on the substrate. Particles of the material of substrate 80 may be removed by the ions striking the substrate, directly proportional to the amount of striking ions. The resulting grooves 82 may be deeper, for a given time of exposure of substrate 80, where the density of the striking beam of ions 70 is greater. To increase the etching effectiveness of the ions it is also possible to induce gas which reacts chemically with the ions and the material of substrate 80. System 300 may also enable production of delicate changes of the period along grating 110, which may affect the spectrum together with the varying depths of sections 42.

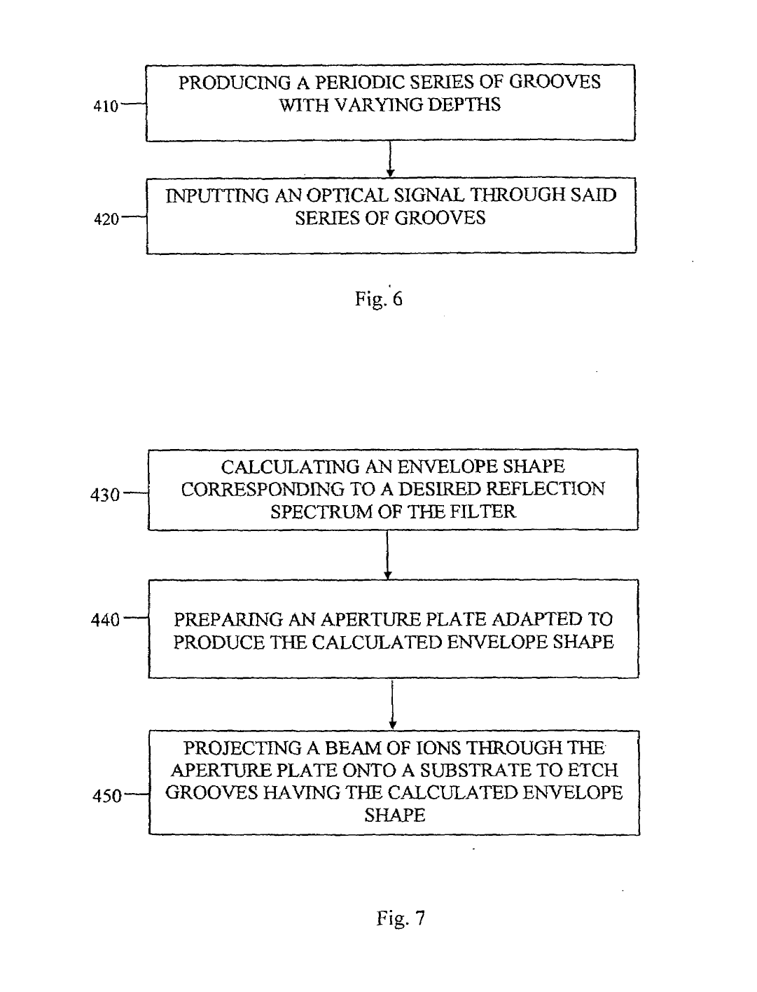

Reference is now made to FIG. 6, which is a flowchart describing a method for wavelength filtering according to embodiments of the present invention. As indicated in block 410, the method may include producing a periodic series of grooves with varying depths, such as sections 42 shown in FIG. 3, for example, by projecting a beam of ions 70 on a substrate 80, as described above with reference to FIGS. 3 and 5. As indicated in block 420, the method may include inputting an optical signal, such as input signal 22 shown in FIG. 3, into the series of grooves. As described above with reference to FIGS. 3 and 4, the spectrum of reflected signal 24 may be affected by envelope shape 44 of the varying depths.

Reference is now made to FIG. 7, which is a flowchart describing a method for producing a wavelength filter according to embodiments of the present invention. As indicated in block 430, the method may include calculating an envelope shape corresponding to a desired reflection spectrum of the filter. As indicated in block 440, the method may include preparing an aperture plate adapted to produce the calculated envelope shape, for example, by producing apertures with varying sizes and densities in the aperture plate, according to the calculated envelope shape. As indicated in block 450, the method may include projecting a beam of ions through the aperture plate onto the substrate, thus, for example, producing varying density of ions along a cross-section line of the beam of ions to etch grooves having the calculated envelope shape.

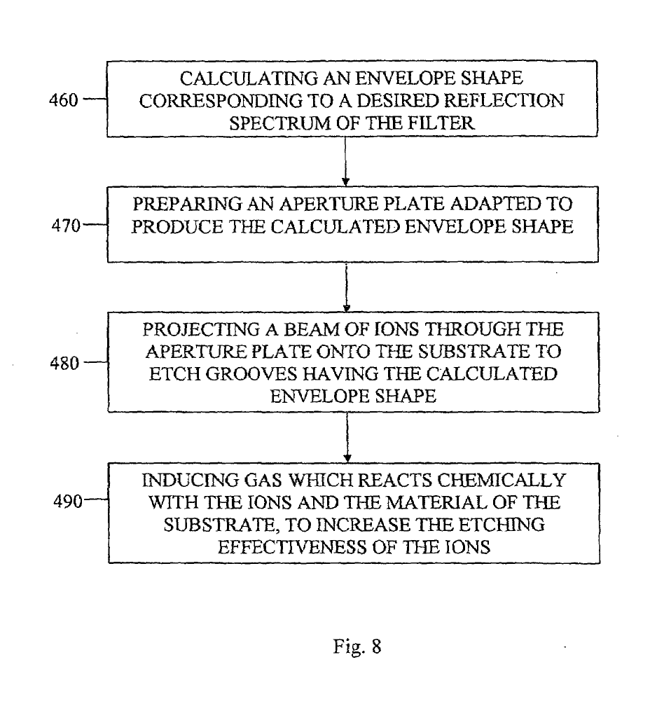

Reference is now made to FIG. 8, which is a flowchart describing a method for producing a wavelength filter according to embodiments of the present invention. In addition to the steps described above, indicated in blocks 460, 470 and 480, the method may further include inducing gas which reacts chemically with the ions and the material of the substrate, to increase the etching effectiveness of the ions, as indicated in block 490.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A wavelength filter comprising:
a waveguide to transmit an optical signal through a substrate;
a periodic series of grooves across a portion of said waveguide to effect reflection of a portion of said signal, said grooves having varying depths along the waveguide, wherein said varying depths affect a spectrum of said reflected portion.

2. A wavelength filter according to claim 1, wherein said spectrum is further affected by the period of said series of grooves and the average refraction index of the periodic series of grooves.

3. A wavelength filter according to claim 1, wherein said spectrum is substantially a spatial Fourier transform of an envelope shape of said varying depths of said grooves.

4. A method for wavelength filtering comprising the steps of:
producing across a portion of a waveguide a periodic series of grooves with varying depths along said waveguide.
inputting an optical signal through said series of grooves, wherein said varying depths affect a spectrum of a reflected portion of said signal.

5. A method according to claim 4, wherein said producing comprises projecting a beam of ions on a substrate, said beam of ions having varying density of ions along a cross-section line of said beam of ions said cross section line substantially parallel to said waveguide.

6. A method according to claim 5, wherein said producing further comprises inducing gas which reacts chemically with said ions and the material of said substrate.

7. A method for producing a wavelength filter having grooves across a waveguide in a substrate, said grooves having varying depths along said waveguide, the method comprising the steps of:
calculating an envelope shape of said varying depths corresponding to a desired reflection spectrum of said filter;
preparing an aperture plate adapted to produce the calculated envelope shape;
projecting a beam of ions through said aperture plate onto said substrate, wherein said beam is structured by said aperture plate to etch grooves having said envelope shape.

8. A method according to claim 7, wherein said preparing comprises producing apertures with varying sizes and densities in said aperture plate, according to the calculated envelope shape.

9. A method according to claim 7, wherein said projecting through said aperture plate produces varying density of ions along a cross-section line of said beam of ions, said cross section line substantially parallel to said waveguide, and wherein said varying depths of said grooves correspond to said varying density of ions.

10. A method according to claim 7, further comprising inducing gas which reacts chemically with said ions and the material of said substrate, to increase the etching effectiveness of the ions.
